(19) United States
(12) Patent Application Publication
(10) Pub. No.: US 2024/0009969 A1
(43) Pub. Date: Jan. 11, 2024

(54) LAMINATE WITH LOW REFLECTANCE AT HIGH INCIDENCE ANGLE

(71) Applicant: AGP America S.A., Ciudad de Panama (PA)

(72) Inventors: Mario Arturo MANNHEIM ASTETE, Lima (PE); Zhaoyu WANG, Lima (PE); José NUNEZ REGUEIRO, Lima (PE); Sebastian M. GOMEZ SOCOLA, Lima (PE); Pooria HOSSEINI, Lima (PE); Massimo MICHETTI, Lima (PE)

(21) Appl. No.: 18/251,051

(22) PCT Filed: Oct. 28, 2021
(86) PCT No.: PCT/IB2021/059999

§ 371 Date: Apr. 28, 2023

Related U.S. Application Data
(60) Provisional application No. 63/106,828, filed on Oct. 28, 2020.

(51) Int. Cl. B32B 17/10

(52) U.S. Cl. CPC B32B 17/10458; B32B 17/10036; B32B 17/10137; B32B 17/10761; B32B 17/10348; B32B 17/10174; B32B 2605/08; B32B 2307/418; B32B 2307/306

(57) ABSTRACT

As car manufacturers have worked to improve the fuel efficiency of their vehicles, one of the areas where they have been able to make major improvements has been aerodynamics. As most of the drag is the result of the frontal area of the vehicle, the installation angle of the windshield has been getting smaller and smaller to facilitate the smooth displacement of air. One of the drawbacks of this approach is that the light reflected back to the driver by the windshield increases as the installation angle decreases and the incidence angle increases. At high incidence angles, the intensity of the reflection may become objectionable. The invention reduces reflection at high incident angles by means of an anti-reflective layer and a polarization layer.

### FIELD OF THE INVENTION

This invention relates to the field of laminated automotive glazing.

### BACKGROUND OF THE INVENTION

As automotive manufacturers have worked to improve the fuel efficiency of their vehicles, in response to government regulations and the public demand for more environmentally friendly vehicles, one of the key areas where they have been able to substantially improve has been in the aerodynamics of the vehicles.

The aerodynamic drag on a vehicle is caused by the displacement of air as the vehicle moves through it. Drag is a function of several variables including but not limited to the density, viscosity and compressibility of the air, and the shape, location, angle of inclination, surface roughness and area of the body panels. We can simplify the calculation of drag by approximating and lumping these factors together as a single variable, the drag coefficient (Cd). The aerodynamic drag on a vehicle (D) is quantified by this unitless number, normally ranging from zero to one.

The lower the coefficient, the lower the drag on the vehicle will be. At a coefficient of 1, the flow of air over the vehicle is primarily turbulent. This is what we would see on a vehicle with a primarily flat and vertical surface on the front of the vehicle. As the coefficient becomes lower, the flow of air becomes smoother and less turbulent consuming less of the vehicle's energy.

The drag coefficient can be calculated through computer simulation or measured by means of physical testing.

If we let A equal to the frontal area of the vehicle perpendicular to the flow direction, r equal the density of air and V equal the velocity, we can calculate the aerodynamic drag D on a vehicle at any given velocity as:

D=C_{d}×A×½×r×V²

Note that due to the velocity squared factor, as the velocity doubles, the drag quadruples. As a result, drag losses tend to be insignificant at low speeds but become substantial at highway speeds. As an example, at a velocity of 100 kph, the drag is 100 times higher than what it is at 10 kph.

In the early days of the industry, most vehicles had near vertical flat body panels and as a result had drag coefficients near 1. As manufacturing technology improved, body panels became more curved, but the glazing remained near vertical and flat. With the introduction of bent glazing, designs started to become more aerodynamic, more for the aesthetics than anything else.

With the rising price of fuel and shortages, in the second half of the 20^{th} century, designers started to pay attention to aerodynamics to improve fuel efficiency.

The once boxy designs with near flat body panels, vertical glass, small radii creases and near right angles began to be replaced with sleek aerodynamic designs that utilized curved body panels with gradual transitions, no break in geometric continuity from panel to panel and windshields set at low installation angles.

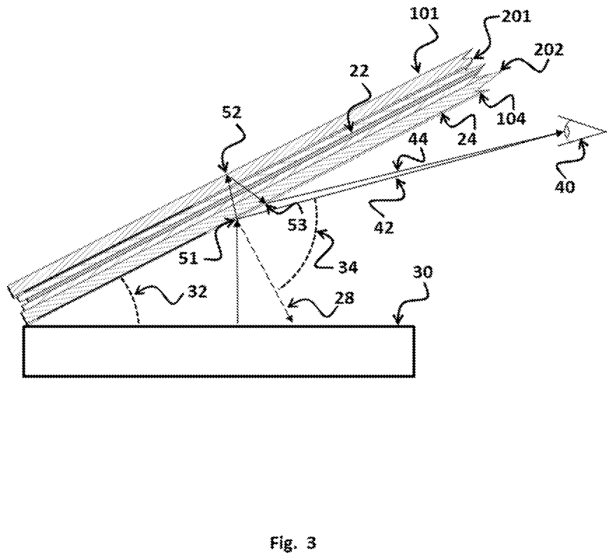

The installation angle 32 of the windshield is defined as the angle made by a cord connecting the top and bottom edge of glass at the vertical centerline relative to the horizontal as illustrated in FIG. 3. A vertical windshield has an installation angle of 90 degrees. As the windshield is rotated from the vertical, with the top edge moving inboard towards the interior, the installation angle 32 decreases.

The windshield is especially important for aerodynamics as it faces into the wind as the vehicle moves forward. The top and pillar portions of the windshield are typically bent to match the curvature of the adjacent sheet metal, reducing turbulence at the transitions. As the installation angle becomes lower, the windshield will tend to present less resistance allowing air to smoothly flow up and over the vehicle. The objective is to reduce turbulent air flow replacing it with smooth laminar flow.

Typical modern passenger vehicles have a Cd in the range of 0.25-0.4. To achieve these drag coefficients, the windshield installation angle is typically less than 40 degrees. On many vehicles, angles of less than 30 degrees are common with some under 20 degrees. Some highly optimize models have a coefficient of drag that is less than 0.2.

Glass reflects light. The percent reflected is a function of the incidence angle, the glass composition and surface condition. The Angle Of Incidence (AOI) 34 is defined as the angle between the propagation direction of a ray incident to a surface 42 and a line perpendicular to the surface at the point of incidence, called the surface normal 28 as shown in FIG. 3. When a ray of light is perpendicular to the glass, the incidence angle is zero. Typical soda-lime float glass 2 reflects ˜8% in total at a zero-incidence angle. The total light reflected is the combined amount reflected from the interior 202 surface 104 of the glass (the interior facing surface of the laminate) and the secondary reflection from the exterior 201 glass surface 101 (the exterior facing surface of the laminate).

A windshield is comprised of laminated glass. There are two layers of glass bonded together by at least one plastic bonding layer, typically a thermoplastic and known as interlayer. The internal glass surfaces have the potential to also reflect light. However, the plastic interlayer used to laminate all safety glass windshields has its refractive index matched to the index of refraction of the glass to prevent internal reflections. A mismatch in the index of refraction at the interface of two materials is what causes light to be reflected.

With a vertical windshield, the installation angle is 90 degrees. The driver line of sight in the forward direction is perpendicular or near throughout the field of view. Light reflected from the top of the instrument panel (dash) will be reflected at a low incidence angle along the driver line of sight.

As the installation angles decreases, the incidence angle of the light reflected from the dash (and other sources) increases, as does the percent of light that is reflected. With a windshield at a low installation angle the reflected light can become objectionable and even unsafe.

As an example, if we have a vehicle with a windshield installed at an angle of 20 degrees, the angle of incidence at the driver's eye-point, looking straight ahead is going to be 90−20=70 degrees. That is, the line of sight makes an angle of 70 degrees relative to the surface normal of the windshield at the point where the line of sight intersects the windshield.

Anyone who has ever placed a map or other light-colored object on the dash of a vehicle with a low installation angle windshield on a sunny day has witnessed this phenomenon.

A common means to overcome this problem has been to use only dark colored textured materials for the top of the instrument panel so that the light reflected by the windshield is not as noticeable. A leather texture is used both for aesthetics and to also reduce the reflection of the dash. In this manner the reflected image is minimized and as a result is not as noticeable or objectionable. In recent years, the manufacturer of a low installation windshield vehicle, with a light-colored dash, was forced to replace the dashboard of many vehicles due to the objectionable reflected image which was alleged to interfere with the safe operation of the vehicle.

While this approach of using darker colors and non-reflective materials may be moderately effective, the constraints that it places on vehicle design and aesthetics is undesirable. In addition, at the installation angle become even smaller, this solution is increasingly less effective. We also have the issue of reflections from internal light sources and objects illuminated by internal and external light sources. A dark dash does nothing to mitigate these reflections.

Another approach has been made use of anti-reflective coatings.

Interference-type multi-layer anti-reflective coatings are comprised of alternating layers of high index of refraction layers and low index of refraction layers. The layers interfere with the reflection of light from the surface.

Another family of coatings are porous graded index coatings wherein the surface is coated, altered, or treated to change the porosity of the surface of the glass. This porosity gradient gives rise to a refractive index gradient. By increasing the porosity, the index of refraction of the surface is lowered and have the same anti-reflective effect as a low index of refraction coating.

Many processes are used to produce both types of coatings including but not limited to: sol gel-spin-coating, sol gel-dip-coating, atmospheric pressure chemical vapor deposition, thermal evaporation, plasma-enhanced chemical vapor deposition, reactive evaporation, electron beam evaporation, and magnetron sputter vacuum deposition.

Anti-reflective coatings are known that reflect less than 1% at a zero-incidence angle.

Anti-reflective coatings, either interference-type multi-layer system or porous graded index coating system, have an intrinsic limitation at a high angle AOI. The level of reflection goes up to an unacceptable level when the AOI becomes large, for example, greater than 70°. Also, the marginal improvement made by a coating has not been viewed as adding sufficient value to justify the added cost.

An approach that could further reduce the level of light reflected to an acceptable level and at a reasonable cost would be of value.

### BRIEF SUMMARY OF THE INVENTION

The invention is an automotive laminate comprising at least two glass layers, at least two plastic interlayers, an anti-reflective layer applied to the glass surface facing the interior of the vehicle and a polarization layer laminated within the glazing. The polarization layer is comprised of a polarization optical film. The polarization optical film can be a reflective polarizer in some embodiments. Reflective polarizer films transmit one polarization of light while reflecting light in the orthogonal polarization. The polarization film is laminated between two plastic bonding layers. The anti-reflecting layer may be comprised of a coating. An anti-reflecting coating comprises a multi-layer stack designed to minimize reflected light. The coating utilizes multiple dielectric layers, of alternating high and low refractive index, to achieve low reflectance, high light transmission and a neutral transmitted color. The coating of the invention is durable, heat and scratch resistant and as such can withstand the glass forming process.

The anti-reflective layer can also comprise a single or multi-layer gradient index porous coating, or Sub-Wavelength Structures (SWS).

The anti-reflective layer can also be achieved by means of a surface treatment of the glass such as an ion exchange in molten salt (such as LiNO₃) or vapor mixture of SO₂ and air to form a gradient index surface layer with a lower index than the bulk glass.

### Advantages

Enables use of low installation windshields
Enables use of a wider range of colors and textures for instrument panels and interiors
Reduces intensity of reflected images.
Improved optical quality.

### BRIEF DESCRIPTION OF THE SEVERAL VIEWS OF THE DRAWINGS

| 1A | Cross section: typical laminated automotive glazing |
|---|---|
| 1B | Cross section: typical laminated automotive glazing with performance |
| | film and coating |
| 1C | Cross section: typical tempered monolithic automotive glazing |
| 2 | Cross section of embodiment 1 |
| 3 | Cross section illustrating driver eye-point |
| 4 | Graph showing total reflectance as a function of AOI |

### REFERENCE NUMERALS OF DRAWINGS

| | |
|---|---|
| 2 | Glass |
| 4 | Bonding/Adhesive layer (plastic Interlayer) |
| 6 | Obscuration/Black Paint |
| 12 | Infrared reflecting film |
| 18 | Infrared reflecting coating |
| 22 | Rotary polarization filter |
| 24 | Anti-reflective coating/treatment |
| 28 | Surface Normal |
| 30 | Instrument Panel (dash) |
| 32 | Installation angle |
| 34 | Angle of Incidence |
| 42 | Primary reflection light ray |
| 44 | Secondary reflection light ray |
| 40 | Eye point |
| 51 | Point 1 |
| 52 | Point 2 |
| 53 | Point 3 |
| 101 | Exterior side of glass layer 1 (201), number 1 surface |
| 102 | Interior side of glass layer 1 (201), number 2 surface |
| 103 | Exterior side of glass layer 2 (202), number 3 surface |
| 104 | Interior side of glass layer 2 (202), number 4 surface |
| 201 | Outer glass layer |
| 202 | Inner glass layer |

### DETAILED DESCRIPTION OF THE INVENTION

The following terminology is used to describe the laminated glazing of the invention.

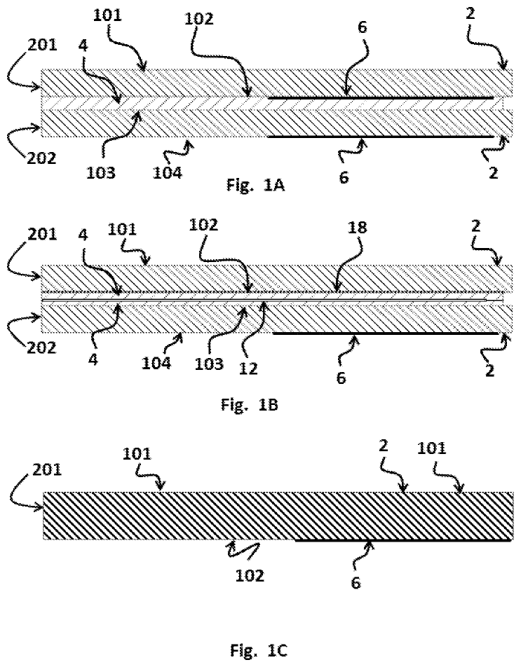

Typical automotive laminated glazing cross sections are illustrated in FIGS. 1A and 1B. A laminate is comprised of two layers of glass, the exterior or outer, 201 and interior or inner, 202 that are permanently bonded together by a plastic bonding layer 4 (interlayer). In a laminate, the glass surface that is on the exterior of the vehicle is referred to as surface one 101 or the number one surface. The opposite face of the exterior glass layer 201 is surface two 102 or the number two surface. The glass 2 surface that is on the interior of the vehicle is referred to as surface four 104 or the number four surface. The opposite face of the interior layer of glass 202 is surface three 103 or the number three surface. Surfaces two 102 and three 103 are bonded together by the plastic layer 4. An obscuration 6 may be also applied to the glass. Obscurations are commonly comprised of black enamel frit printed on either the number two 102 or number four surface 104 or on both. The laminate may have a solar coating 18 on one or more of the surfaces. The laminate may also comprise a film 12 laminated between at least two plastic layers 4.

FIG. 1C shows a typical tempered automotive glazing cross section. Tempered glazing is typically comprised of a single layer of glass 201 which has been heat strengthened.

The glass surface that is on the exterior of the vehicle is referred to as surface one 101 or the number one surface. The opposite face of the exterior glass layer 201 is surface two 102 or the number two surface. The number two surface 102 of a tempered glazing is on the interior of the vehicle. An obscuration 6 may be also applied to the glass. Obscurations are commonly comprised of black enamel frit printed on the number two 102 surface. The glazing may have a coating 18 on the number one 101 and/or number two 102 surfaces.

The term “glass” can be applied to many inorganic materials, include many that are not transparent. For this document we will only be referring to transparent glass. From a scientific standpoint, glass is defined as a state of matter comprising a non-crystalline amorphous solid that lacks the ordered molecular structure of true solids. Glasses have the mechanical rigidity of crystals with the random structure of liquids.

Glass is formed by mixing various substances together and then heating to a temperature where they melt and fully dissolve in each other, forming a miscible homogeneous fluid.

A glazing is an article comprised of at least one layer of a transparent material which serves to provide for the transmission of light and/or to provide for viewing of the side opposite the viewer and which is mounted in an opening in a building, vehicle, wall or roof or other framing member or enclosure.

Laminates, in general, are articles comprised of multiple sheets of thin, relative to their length and width, material, with each thin sheet having two oppositely disposed major faces and typically of relatively uniform thickness, which are permanently bonded to one and other across at least one major face of each sheet.

Laminated safety glass is made by bonding two sheets (201 & 202) of annealed glass 2 together using a plastic bonding layer comprised of a thin sheet of transparent plastic 4 (interlayer) as shown in FIG. 1.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic layer helping to maintain the structural integrity of the glass. A vehicle with a broken windshield can still be operated. The plastic layer 4 also helps to prevent penetration by objects striking the laminate from the exterior and in the event of a crash occupant retention is improved.

The types of glass that may be used include but are not limited to: the common soda-lime variety typical of automotive glazing as well as aluminosilicate, lithium aluminosilicate, borosilicate, glass ceramics, and the various other inorganic solid amorphous compositions which undergo a glass transition and are classified as glass included those that are not transparent. The glass layers may be comprised of heat absorbing glass compositions as well as infrared reflecting and other types of coatings.

Automotive glazing often makes use of heat absorbing glass compositions to reduce the solar load on the vehicle. While a heat absorbing window can be effective the glass will heat up and transfer energy to the passenger compartment through convective transfer and radiation. A more efficient method is to reflect the heat back to the atmosphere allowing the glass to stay cooler. This is done using various infrared reflecting films and coatings commonly referred to as Low E or solar coatings in the industry. Infrared coatings and films are generally too soft to be mounted or applied to a glass surface exposed to the elements. Instead, they must be fabricated as one of the internal layers of a laminated product to prevent damage and degradation of the film or coating.

One of the big advantages of a laminated window over a tempered monolithic glazing is that a laminate can make use of infrared reflecting coatings and films in addition to heat absorbing compositions and interlayers.

Infrared reflecting solar coatings 18 include but are not limited to the various metal/dielectric layered coatings applied though Magnetron Sputtered Vacuum Deposition (MSVD) as well as others known in the art that are applied via pyrolytic, spray, Chemical Vapor Deposition (CVD), dip and other methods.

Infrared reflecting solar films include both metallic coated plastic substrates as well as organic based non-metallic optical films which reflect in the infrared. Most of the infrared reflecting films are comprised of a plastic film substrate having an infrared reflecting layered metallic coating applied.

A wide range of coatings, used to enhance the performance and properties of glass, are available and in common use. These include but are not limited to anti-reflective, hydrophobic, hydrophilic, self-healing, self-cleaning, anti-bacterial, anti-scratch, anti-graffiti, anti-fingerprint, and anti-glare. All of which may be used in conjunction with the glazing of the invention.

The anti-reflective coating layer of the disclosed embodiments of the invention is applied by means of an MSVD coater to the flat glass prior to bending. However, this is not a limitation. Any coating that serves to reduce the reflected level of light, applied by any means may be substituted. Other embodiments may comprise an anti-reflective layer comprising a Graded Index porous surface layer applied by means of liquid coating methods such as spray, slot die or other means as well as sub-wavelength structures produced by a lithography process. Likewise, in place of an anti-reflective coating, an anti-reflective surface treatment may be used, such as ion exchange process to generate a Graded Index surface layer.

The plastic bonding layer 4 (interlayer) has the primary function of bonding the major faces of adjacent layers to each other. The material selected is typically a clear thermoset plastic.

For automotive use, the most used bonding layer 4 (interlayer) is PolyVinyl Butyral (PVB). PVB has excellent adhesion to glass and is optically clear once laminated. It is produced by the reaction between polyvinyl alcohol and n-butyraldehyde. PVB is clear and has high adhesion to glass. However, PVB by itself, it is too brittle. Plasticizers must be added to make the material flexible and to give it the ability to dissipate energy over a wide range over the temperature range required for an automobile. Only a small number of plasticizers are used. They are typically linear dicarboxylic esters. Two in common use are di-n-hexyl adipate and tetra-ethylene glycol di-n-heptanoate. A typical automotive PVB interlayer is comprised of 30-40% plasticizer by weight.

In addition to polyvinyl butyl, ionoplast polymers, Ethylene Vinyl Acetate (EVA), Cast In Place (CIP) liquid resin and Thermoplastic PolyUrethane (TPU) can also be used. Automotive interlayers are made by an extrusion process with has a thickness tolerance and process variation. As a smooth surface tends to stick to the glass, making it difficult to position on the glass and to trap air, to facilitate the handling of the plastic sheet and the removal or air (deairing) from the laminate, the surface of the plastic is normally embossed contributing additional variation to the sheet. Standard thicknesses for automotive PVB interlayer at 0.38 mm and 0.76 mm (15 and 30 mil).

A wide variety of films are available that can be incorporated into a laminate. The uses for these films include but are not limited to: solar control, variable light transmission, increased stiffness, increased structural integrity, improved penetration resistance, improved occupant retention, providing a barrier, tint, providing a sunshade, color correction, and as a substrate for functional and aesthetic graphics. The term “film” shall include these as well as other products that may be developed or which are currently available which enhance the performance, function, aesthetics, or cost of a laminated glazing. Most films do not have adhesive properties. To incorporate into a laminate, sheets of plastic interlayer are typically used on each side of the film to bond the film to the other layers of the laminate. In place of one of the sheets of plastic interlayer typically PVB, EVA or PU, the film may be bonded to the glass by means of an optical adhesive such as OCA (optical clear adhesive) or OCR (optical clear resin) such as liquid optically clear adhesive, UV curable resin, polymer, silicone, acrylic, urethane, sulfide based and combinations thereof. In the contrary of using a plastic bonding layer or film this option allows for lamination with just a single sheet of interlayer. In this case, the optical adhesive serves as and replaces one of the typical plastic bonding layers.

As can be appreciated, there are numerous anti-reflective coatings that may be used to implement the glazing of the invention. No one specific coating is required to be used to implement the glazing of the invention. While the efficiency may vary substantially, all serve to reduce the quantity of light reflected by the surface of the glass and as such are viewed as functional equivalents and therefore falling within the scope of the invention.

The polarization of light is inherent and independent of the AOI. If the optical field is oscillating in a plane parallel to the propagation plane, then the light is p-polarized. If the field oscillates in a plane perpendicular to the propagation plane, then it is s-polarized. Various types of polarization layers may be used including but not limited to rotary, linear and reflective. The embodiments disclosed herein make use of a reflective polarizer Windshield Combiner Film (WCF). This film is designed for use in windshields used with head up display projectors.

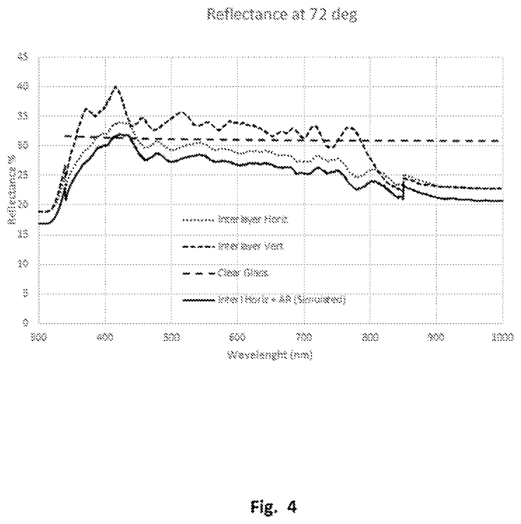

Optical data for an embodiment of the invention, comprising a WCF polarization layer and a MSVD anti-reflective coating layer on surface four is shown in the graph of FIG. 4.

In the critical range of 60-70 degrees, corresponding to the driver line of sight with a windshield having an installation angle of 20-30 degrees, the reflected image is reduced by close to 10% as compared to a conventional laminate.

In FIG. 3, the principle of operation is illustrated. Note the drawing is not to scale and that the dimensions and angle are exaggerated to better illustrate the concept.

Light is reflected by the instrument panel 30, striking the windshield on the surface 104 of the inner glass layer 202 at point 1 51. The anti-reflective coating 24, through interference, attenuates a portion of the light that would otherwise be reflected. The light is reflected at point 1 51 traveling along the primary reflection path 42 to the observer 40. Some of the light enters the glass 202 at point 1 51 where it is diffracted changing direction. The light passes through the rotary polarization filter 22 where a portion of the out of phase light is attenuated. The light continues through the outer glass layer 201 where it strikes the number 1 101 surface at point 2 52 where some of the light is transmitted exiting the glazing and some is reflected. The reflected light passes through the rotary polarizing filter 22 a second time. Any light that has shifted polarization and is out of phase with the filter is attenuated. The light continues to the number four surface 104 of the inner glass layer 202 where it exits the glass surface at point 3 53 and travels along the secondary image path 44 to the observer 40.

The rotary polarizing filter or the polarizing optical film 22 of the embodiments becomes a permanent integral part of the laminate. Rather than laminating the two glass layers with a single 0.76 mm layer of PVB plastic bonding interlayer 4, two sheets of 0.38 mm are used to sandwich the rotary polarizing filter between them. During the autoclave process, the PVB bonds to the polarization film and to the glass layers. This is a common method used to laminate various performance films in the industry.

Alternately, the rotary polarizing filter 22 may be optically bonded to one of the glass layers and then laminated requiring only a single sheet of PVB interlayer.

The optical polarizing layer may also be implemented as a coating or surface treatment applied to a film or glass layer without departing from the principle and claims of the invention.

While the embodiments described are windshields, the invention may be applied to any glazing in any position without departing from the intent of the invention. Reflected light from panoramic roofs is becoming more and more objectionable to consumers due to the proliferation of LED cabin lighting as well as the large bright displays used in the instrument panel. It is more of a problem in part due to the relatively low transmitted light levels, through glazed roofs with some as low as 2%. Due to the low transmitted level, the reflected light may be as bright or brighter than the transmitted. When looking out, the passenger may only see the reflection of the interior.

The laminate of the invention is especially effective in reducing the brightness of the reflection from LCD type displays as the light emitted is already polarized allowing the filter in the laminate to block some of the light as it passes through the filter and again as it is reflected back form the exterior number four surface.

### DESCRIPTION OF EMBODIMENTS

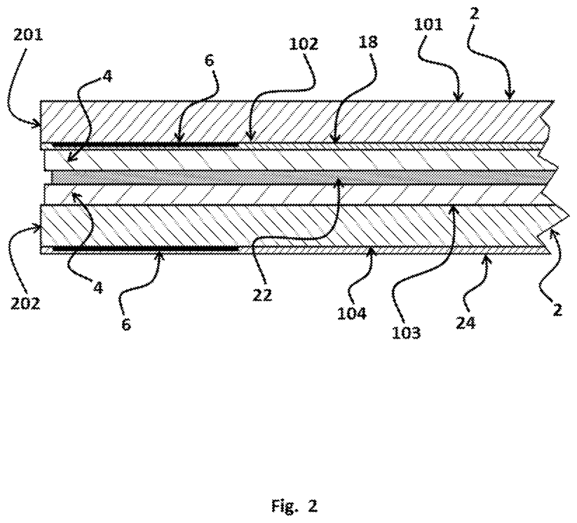

1. Embodiment one is shown in cross section in FIG. 2 and comprises a large 1.2 square meter laminated automotive windshield with a 2.1 mm thick ultra-clear soda-lime outer glass layer 201 with a solar coating 18 applied to the number two surface 102, a 2.1 mm thick solar green inner glass layer with an anti-reflective coating 24 applied to the number four surface 104, two layers of 0.37 mm thick PVB 4 interlayer and a rotary polarization filter 22. The windshield is installed at an angle of 22 degrees to horizontal.

The inner 202 and outer 201 glass layers are cuts to size, the edges are grounded, and the layers are washed. Each layer is then screen printed with a black enamel frit 6. The glass layers are heated to fire the frit.

A complex multi-layer solar control coating 18, with four silver layers separated by di-electric layers having a thickness of 300 nm, is applied to the number two surface 102 of the outer glass layer 201. A 200 nm thick, four-layer, anti-reflective coating 24, comprising alternating layers of high and low index of refraction dielectrics, is applied to the number four surface 104 of the inner glass layer 202. Both coatings are applied to the flat glass by means of an MSVD coater.

The flat glass 2 is heated and bent to shape by means of a singlet pressing process and then annealed. The laminate is assembled placing two 0.36 thick layers of embossed PVB interlayer 4 between the two glass layers. A sheet of reflective polarization WCF film 22, with a thickness of 60 um, is placed between the two plastic interlayer sheets.

The assembly is then processed by means of a typical standard automotive windshield autoclave lamination process.
2. Embodiment 2 is the same as embodiment 1 with the exception that a solar coating is not applied, and the inner and outer glass layers are both comprised of solar green glass.
3. Embodiment 3 is the same as embodiment 2 with the exception that it further comprises a solar control coating deposited on the polarizing optical film.
4. Embodiment 4 is the same as embodiment 1 except for the anti-reflective layer. The anti-reflective layer is a porous graded index Silicon coating with an effective refractive index of 1.32.
Embodiment 5 is the same as embodiment 1 except for the anti-reflective layer. The anti-reflective layer is produced by means of an ion-exchange surface treatment in which the glass is placed in contact with in molten LiNO₃ to form a gradient index surface layer with a lower index than the bulk glass.
6. Embodiment 6 is the same as embodiment 1 except for the anti-reflective layer. The anti-reflective layer is produced by means of an ion-exchange surface treatment in which the glass is exposed to a vapor mixture of SO₂ and air to form a gradient index surface layer with a lower index than the bulk glass.
7. Embodiment 7 is the same as embodiment 2 with the exception that the polarizing optical film is a reflective polarizer film.
8. Embodiment 8 is the same as embodiment 2 with the exception that two PVB interlayers, the laminate comprises one interlayer and one liquid optically clear adhesive layer to sandwich the polarizing optical film and bond it to the laminate.

What is claimed is:

1. An automotive laminate having an interior facing surface and an exterior facing surface comprising:
at least two glass layers,
at least two bonding layers positioned between the glass layers
a polarizing optical layer, disposed between said at least two bonding layers,
an anti-reflective layer wherein the layer is deposited on the interior facing surface of the laminate.

2. The automotive laminate of claim 1 wherein the polarizing optical layer is a reflective polarizer film.

3. The automotive laminate of claim 1 wherein the polarizing optical layer is a rotary polarizer film.

4. The automotive laminate of claim 1 wherein the polarizing optical layer is a WCF film.

5. The automotive laminate of any one of the preceding claims further comprises a solar coating.

6. The laminate of any one of claims 1 to 4 further comprises a solar film.

7. The automotive laminate of any one of the preceding claims wherein the optical polarizing layer is a film that comprises a solar coating.

8. The automotive laminate of any one of the preceding claims is a windshield.

9. The automotive laminate of any one of claims 1 to 7 is a roof.

10. The automotive laminate of any one of claims 1, 5-6 and 8-9 wherein the polarizing optical layer is comprised of a coating.

11. The automotive laminate of any one of the preceding claims wherein the anti-reflective layer is comprised of alternating layers of high and low refractive index materials.

12. The automotive laminate of any one of claims 1 to 10 wherein the anti-reflective layer is comprised of a porous graded index coating.

13. The automotive laminate of any one of claims 1 to 10 wherein the anti-reflective layer is comprised of an ion exchange chemical tempering surface treatment.

14. The automotive laminate of any one of the preceding claims wherein the anti-reflective layer is resistant to heat sufficient to allow for thermal forming of the glass.

15. The automotive laminate of any one of the preceding claims wherein one of the bonding layers is an optical adhesive.

16. The automotive laminate of any one of claims 1 to 14 wherein at least one of said at least two bonding layers is a plastic bonding layer chosen from the group consisting of: PVB, EVA or PU.

17. The automotive laminate of any one of claims 1 to 14 wherein at least one of said at least two bonding layers is a plastic bonding layer chosen from the group consisting of: PVB, EVA or PU and the other bonding layer is an optical adhesive.
